(19) United States
(12) Patent Application Publication
(10) Pub. No.: US 2014/0118199 A1
(43) Pub. Date: May 1, 2014

(54) LOW PROFILE APPLIQUE ANTENNA

(71) Applicant: GM GLOBAL TECHNOLOGY OPERATIONS LLC, Detroit, MI (US)

(72) Inventors: Gregg R. Kittinger, Pontiac, MI (US); Donald B. Hibbard, JR., Howell, MI (US)

(73) Assignee: GM GLOBAL TECHNOLOGY OPERATIONS LLC, Detroit, MI (US)

(21) Appl. No.: 13/665,018

(22) Filed: Oct. 31, 2012

(51) Int. Cl. H01Q 1/32

(52) U.S. Cl. 343/713

(57) ABSTRACT

An applique antenna for an automobile comprises a body panel having a body panel outer surface and a body panel cavity. An applique is configured to be received in the body panel cavity and to continue the styling lines of the body panel outer surface with a flush fit. A cavity is defined between the body panel cavity and the applique. An antenna structure is disposed within the cavity and is decoupled from the body panel cavity by the applique.

### FIELD OF THE INVENTION

Exemplary embodiments of the invention are related to antennas and associated vehicle assemblies.

### BACKGROUND

The electronic age, and miniaturization of electronics, has provided the ability for mass connectivity as exemplified by the desire for connectivity in virtually every aspect of life. Mobile connectivity, such as in an automobile or other motor vehicle, is highly desirable considering the extended periods of time the average individual now spends commuting to work, as well as to other activities. Multiple devices are now available in vehicles that allow individuals to “connect” with the outside world while operating a motor vehicle. Such devices include such traditional devices such as a radio but also include more complex navigational systems, mobile phones and other information and communication systems. Most, if not all of these systems, rely upon clear connections to external networks for transmission and receipt of information and, as such, require some form of antenna for connection thereto.

Traditionally motor vehicle antennas have been attached to the vehicle body (fender, roof, and window) where they have been prone to breakage, vandalism, and corrosion due to the perforation of a vehicle panel. In addition, from an aesthetics standpoint, a vehicle bristling with antennae is less than desirable and may detract from the vehicle's overall fuel efficiency by increasing its drag coefficient. One solution has been to develop hidden antenna elements such as stamped aluminum sheets or wires which are disposed in various vehicle panels. However, with the recent interest in electric and hybrid vehicles, an antenna disposed within or close to the interior of the vehicle may have its performance compromised by Electro-Magnetic Currents (“EMC”) emitted by the drive systems of these vehicles which can very easily interfere with the various bandwidths (especially AM 540 to 1800 Khz and FM 88 to 108 MHZ both analog and digital content in these bandwidths). Therefore it is desirable to design antennae as well as the host vehicles to avoid these difficulties.

### SUMMARY OF THE INVENTION

In an exemplary embodiment, an applique antenna for an automobile comprises a body panel having a body panel outer surface and a body panel cavity. An applique is configured to be received in the body panel cavity and to continue the styling lines of the body panel outer surface with a flush fit. A cavity is defined between the body panel cavity and the applique and an antenna structure is disposed within the cavity and decoupled from the body panel cavity by the applique.

In another exemplary embodiment, an automobile having a rear deck lid comprises a deck lid cavity formed in a deck lid outer surface along a rearmost edge thereof. An applique is configured to be received in the deck lid cavity and to continue the styling lines of the deck lid outer surface with a flush fit that is virtually undetectable from the exterior of the automobile. A cavity is defined between the deck lid cavity and the applique and an antenna structure is disposed within the cavity and decoupled from the deck lid outer surface by attachment to the applique.

The above features and advantages, and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a partial isometric view of a rear portion of an automobile embodying features of the invention;

FIG. 2 is a partial cross-sectional view of the automobile of FIG. 1 taken at Section line 2-2; and

FIG. 3 is a schematic isometric view of a deck lid panel cavity embodying features of the invention.

### DESCRIPTION OF THE EMBODIMENTS

The following description is merely exemplary in nature and is not intended to limit the present disclosure, it application or uses. It should be understood that throughout the drawings, corresponding reference numerals indicate like or corresponding parts and features.

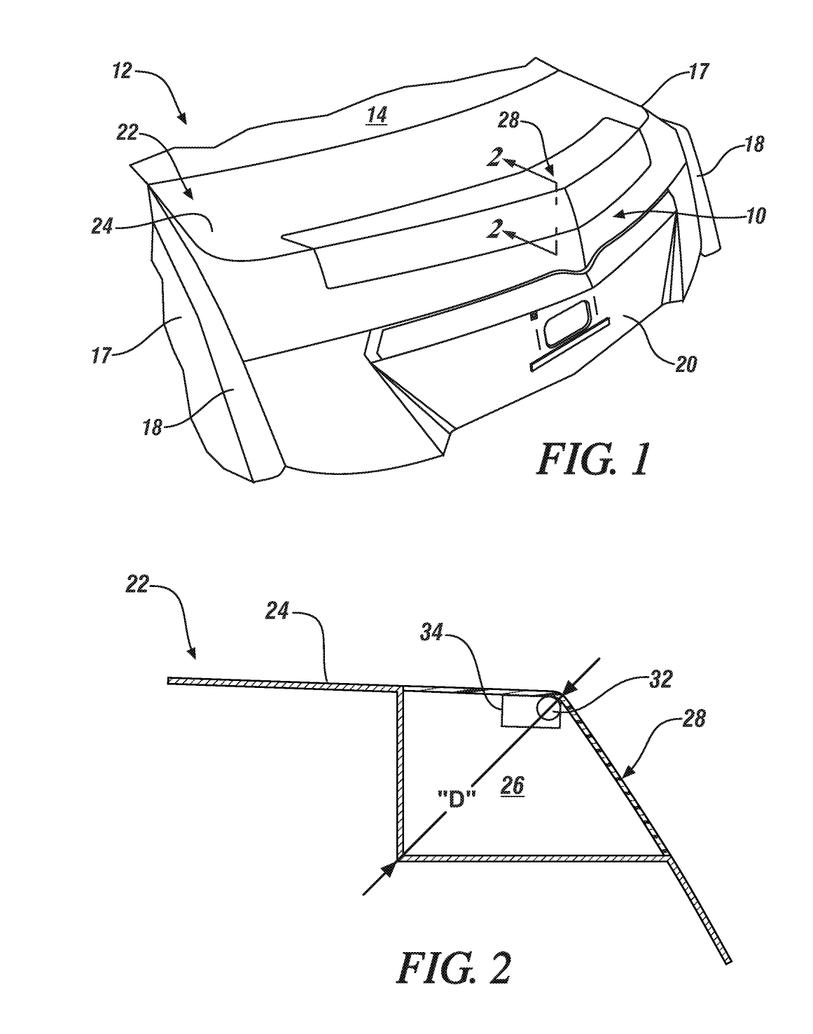

Referring to FIG. 1, in an exemplary embodiment a rear portion 10 of an automobile 12 is illustrated. The automobile 12 in the figure is a sedan style passenger car; however the invention to be described herein should not be limited in its application to only such a vehicle style as many other vehicle styles will also accept similar applications thereof. The rear portion 10 of the automobile 12 may comprise several assemblies, namely a rear window 14, rear body panels comprising fenders 17 and a deck lid 22, tail lights 18 and a rear facia 20 assembly.

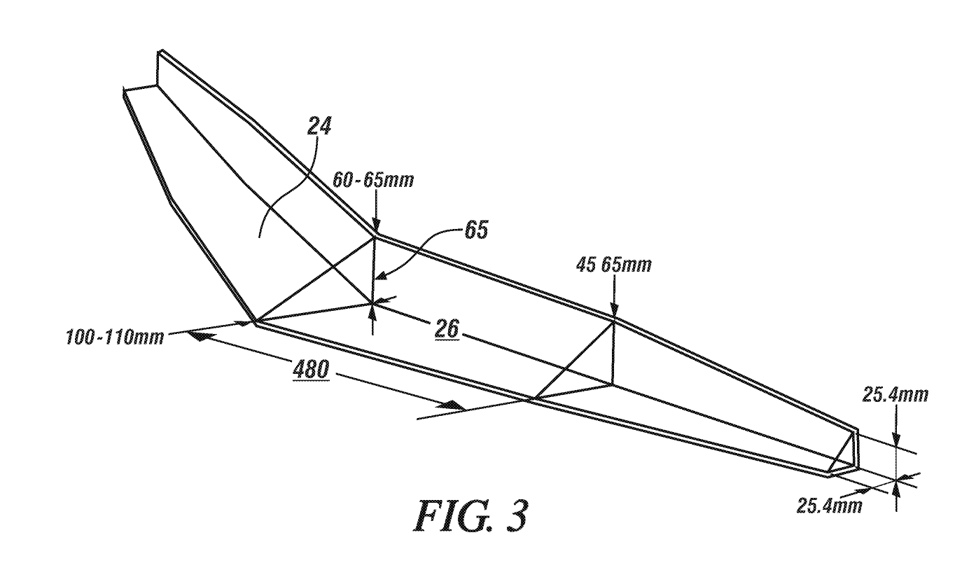

In an exemplary embodiment, and referring to FIGS. 2 and 3 with continuing reference to FIG. 1, the rear body panels such as rear deck lid outer surface 24 may include a cavity such as deck lid panel cavity 26 which is formed along the rearmost edge. The deck lid panel cavity 26 is configured to receive an applique 28 therein. The applique continues the styling lines of the surface of the rear deck lid body panel 22 and thus the rear portion 10 of the automobile 12 by fitting flush with the deck lid outer surface. 24. The applique may be painted and is virtually undetectable to a viewer of the vehicle. In addition the applique 28 closes the deck lid panel cavity 26 which is then configured to contain an antenna structure 32 and an antenna amplifier 34 (optional). In an exemplary embodiment, the applique 28 is constructed of a non-conductive materials such as SMC, Fiberglass, ABS or other suitable materials allowing the antenna structure 32 to be decoupled from the sheet metal of the deck lid panel 24 thereby facilitating tuning of the antenna and isolating the antenna 32 from Electro-Magnetic Currents (“EMC”) emitted from various systems of the automobile 12.

In the exemplary embodiment shown in FIG. 3, the deck lid panel cavity 26 formed in the deck lid panel out surface 24 should be configured to maximize the distance “D” between the antenna structure 32 and the metal surface of the rear deck lid panel 24. In the embodiment shown in FIG. 3, the vertical height of the deck lid panel cavity 26 at the centerline of the rear portion 10 of the automobile 12 is in the range of 60-65 mm with the horizontal depth in the range of 100-110 mm. The vertical height and horizontal depth of the deck lid panel cavity 26 between the centerline of the rear portion 10 of the automobile 12 and its outer portion 36 are in the in the range of 45 mm and 65 mm, respectively and the vertical height and horizontal depth of the deck lid panel cavity 26 between the at its outer portion 36 are in the in the range of 25.4 mm. In another exemplary embodiment of the invention, the applique may receive a lens portion through which a high mounted brake light may be installed. In addition it should be clear to one of skill in the art that the invention just described is not necessarily limited in its application to the rear deck lid panel of a sedan style automobile but may be easily configured to apply to applications such as roof panels, body panels such as the rear body panels shown in FIG. 1, tailgates and other available surfaces. The dimensions provided above where designed for the FM band 3 meter. If a higher frequency antenna is used (ex. cellular or RFR 900 mhz+, 315 mhz or remote function bands) the cavity may be reduced in size. More particularly the cavity is tuned to the frequency band desired to be received.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. An applique antenna for an automobile comprising:
a body panel having a body panel outer surface and a body panel cavity;
an applique configured to be received in the body panel cavity, to continue styling lines of the body panel outer surface with a flush fit and to close the body panel cavity;
an antenna structure disposed within the closed body panel cavity and decoupled from the body panel by the applique.

2. The applique antenna of claim 1, the body panel comprising a deck lid.

3. The applique antenna of claim 1, the applique constructed of a non-conductive material for attachment of the antenna thereto and decoupling of the antenna from the body panel.

4. The applique antenna of claim 3, wherein the antenna is isolated from Electro-Magnetic Currents (“EMC”) emitted from various systems of the automobile.

5. The applique antenna of claim 1, comprising a lens portion through which a high mounted brake light may be mounted.

6. The applique antenna of claim 1, wherein the applique may be painted and is virtually undetectable from the exterior of the vehicle.

7. The applique antenna of claim 1, wherein the vertical height of the body panel cavity at the centerline of a portion of the automobile is in the range of 60-65 mm and the horizontal depth is the range of 100-110 mm.

8. The applique antenna of claim 1, wherein the vertical height of the body panel cavity is tuned to the frequency band desired to be received.

9. An automobile having a rear deck lid comprising:
a deck lid cavity formed in a deck lid outer surface along a rearmost edge of the rear deck lid;
an applique configured to be received in the deck lid cavity, to continue styling lines of the deck lid outer surface with a flush fit that is virtually undetectable from the exterior of the automobile, and to close the deck lid cavity;
an antenna structure disposed within the closed deck lid cavity and decoupled from the deck lid outer surface by attachment to the applique.

10. The automobile of claim 9, the applique constructed of a non-conductive material.

11. The automobile of claim 10, wherein the antenna is isolated from Electro-Magnetic Currents (“EMC”) emitted from various systems of the automobile.

12. The automobile of claim 9, wherein the applique may be painted.

13. The automobile of claim 9, wherein the vertical height of the deck lid cavity at the centerline of a rear portion of the automobile is in the range of 60-65 mm and the horizontal depth is the range of 100-110 mm.

14. The automobile of claim 9 comprising one of an electric or a hybrid powered automobile.

15. The automobile of claim 9, wherein the vertical height of the body panel cavity is tuned to the frequency band desired to be received.

16. An applique antenna for an automobile comprising:
a body panel having a body panel outer surface and a body panel cavity;
an applique configured to be flushly received in the body panel cavity, to continue styling lines of the body panel outer surface with a flush fit and to close the body panel cavity;
an antenna structure disposed within the closed body panel cavity and decoupled from the body panel by the applique.

17. The applique antenna of claim 16, the body panel comprising a rear deck lid.

18. The applique antenna of claim 16, the applique constructed of a non-conductive material for attachment of the antenna thereto and decoupling of the antenna from the rear body panel.

19. The applique antenna of claim 18, wherein the antenna is isolated from Electro-Magnetic Currents (“EMC”) emitted from various systems of the automobile.

20. The applique antenna of claim 16, wherein the vertical height of the body panel cavity is tuned to the frequency band desired to be received.
